(19) United States
(12) Patent Application Publication
(10) Pub. No.: US 2003/0029697 A1
(43) Pub. Date: Feb. 13, 2003

(54) Rotary transfer machine

(76) Inventors: Lanny Green, Grass Lake, MI (US); Robert E. Betzig, Ann Arbor, MI (US)

Correspondence Address: OLSON & HIERL, LTD., 36th Floor, 20 North Wacker Drive, Chicago, IL, 60606, US

(21) Appl. No.: 09/928,723

(22) Filed: Aug. 13, 2001

(51) Int. Cl. B65G 47/84; B65G 47/24

(52) U.S. Cl. 198/377.02; 198/377.03; 198/377.06; 198/478.1

(57) ABSTRACT

The present invention relates generally to a rotary transfer machine for machining workpieces, and more particularly to a rotary apparatus for presenting workpieces to a multi-spindle machining cell. The rotary transfer machine comprises an index table having plural index stations having corresponding indexing axes and dedicated workpiece fixtures mounted at the index stations. The workpiece fixtures are adapted to hold a workpiece and present a face thereof to be machined at a desired offset from the corresponding indexing axes of the index stations while presenting that face for machining to a pre-determined spindle or spindles of the machining cell.

### FIELD OF INVENTION

The present invention relates generally to a rotary transfer machine for machining workpieces, and more particularly to a rotary apparatus for presenting workpieces to a multi-spindle machining cell comprising an index table having plural index stations and workpiece fixtures mounted at the index stations.

### BACKGROUND OF INVENTION

Rotary transfer machines are known for high volume mass production where machining operations are required to complete a part or workpiece. Known rotary transfer machines rotate and index workpieces to multiple machining stations with a rotary index table mounted in the center of the multiple stations. A drive control rotates and indexes the table, thereby cycling the workpieces sequentially through the stations. Various operations can be performed at each machining station as desired, including but not limited to milling, drilling, cross drilling, boring, internal and external recessing, threading, tapping, broaching and other machining operations.

Heretofore utilized rotary index tables typically have a plurality of fixtures designed to clamp or hold workpieces in a desired position. The fixtures may be fixed either relative to the index table or may be capable of being rotated, tilted or otherwise moved relative to the index table to allow more sides of the workpiece to be exposed to each machining station. The available work envelope is quite limited, however.

It is also known in the art that machining stations may include multiple spindles for performing selected machining operations. Multi-spindle machining stations require that adjustments to the relative positioning between the machining station and the workpiece be made in-process in order to correctly align the desired spindle with the intended face of the workpiece. Examples of such adjustments include rotating or tilting the workpiece and/or machining station, and in some cases, tilting the entire index table. Again, these additional moving parts increase the possibility of error in positioning of the workpiece relative to the spindle, and present extra parts that may fail, as well as increasing machining time.

### SUMMARY OF THE INVENTION

The present invention facilitates the optimization of the available work envelope for a multi-spindle machining cell or station so that a maximum number of spindles, performing a maximum number of operations, can be included in a single machining cell. A further advantage is that successive fixtures can be positioned on an index table to allow two or more faces on a workpiece to be machined to share a single spindle. Yet another advantage is that the number of moving parts in a rotary index table can be reduced.

To that end, a fixture on an index table is assigned for machining each face of a given workpiece or part, while all, or a desired number of, machining operations on the workpiece are performed by the same machining cell or station. Each such dedicated fixture is configured to pre-position a particular workpiece face with at least one spindle in the multi-spindle array and in an available work envelope for that particular spindle, thus obviating the need for shifting the position of the machining cell or its station, or relocating the workpiece itself. Fixtures sharing a common mounting element can be built as common sub-assemblies customized through an appropriate bracket to provide a desired workpiece orientation for a particular fixture mounted to the same index table.

Rotary apparatus for presenting workpieces to at least one multi-spindle machining cell or station for a machining operation and embodying the present invention includes a rotatable index table having plural index stations situated along radial axes extending outwardly from the center of the index table (indexing axes), and a workpiece fixture mounted to the index table at each of the plurality, i.e., at least two, of available index stations and at a pre-determined position along the respective indexing axes. At least one of the mounted workpiece fixtures is adapted to present, at an index station, a preselected workpiece face to be machined to at least one pre-determined spindle of the multi-spindle machining cell so that the preselected workpiece face is offset from the indexing axis of the index station for that mounted workpiece fixture. The offset can be horizontal, vertical, rotational, or all three, as desired. In this manner the available work volume in a particular work envelope for a pre-determined spindle in an array of spindles available in a machining cell or cells can be maximized because the workpiece face to be machined is appropriately pre-positioned (usually centered) within the work envelope for the particular pre-determined spindle. Thus, the effective available work envelopes for the machining cell or cells can be increased, and each spindle can be utilized efficiently. The fixture position can also be adjusted relative to the axes of the individual spindles so that spindles not machining a particular face nevertheless clear the workpiece.

### BRIEF DESCRIPTION OF THE DRAWINGS

In the drawings,

FIG. 1 is a plan view of an index table having eight index stations and a dedicated fixture mounted to each index station, with Index Station A situated at machining cell 14, and each dedicated fixture holding a workpiece at an offset from the indexing axis for that particular index station;

FIG. 2 is a side elevation view of workpiece 31 held in fixture 41 mounted at Index Station A as viewed from the perspective plane 2-2 which indicates the approximate location of a machining cell;

FIG. 3 is a plan view of an index table having eight index stations and a dedicated fixture mounted to each index station with Index Station C situated at machining cell 14, each dedicated fixture holding a workpiece at a translational offset from the indexing axis for that particular index station; and

FIG. 4 is a side elevation view of workpiece 33 held in fixture 43 mounted at Index Station C from the perspective plane 2-2 which indicates the approximate location of a machining cell.

### DESCRIPTION OF PREFERRED EMBODIMENTS

The invention disclosed herein is susceptible to embodiment in many different forms. Shown in the drawings and described in detail hereinbelow are certain preferred embodiments of the present invention. The present disclosure, however, is an exemplification of the principles and features of the invention, but does not limit the invention to the illustrated embodiments.

These embodiments provide freedom of positioning for a workpiece to be machined along the indexing axis for a given index station, and not only translationally but also rotationally relative to the indexing axis so as to optimize the available work volumes for the work envelopes available for a given machining cell or cells. Each fixture is mounted to the index table along a radially outwardly extending indexing axis in the plane of the index table and can provide orientation of the workpiece to be machined, such as a casting or the like, so as to position a face thereof to be machined not only perpendicular to the axes of the spindles that are to be used for machining that face at that particular index station, but also so as to insure that spindles present within the machining cell but not used for machining at that particular station do not interfere or collide with the oriented workpiece at the machining station. The foregoing optimization of orientation is achieved by utilization of dedicated fixtures mounted to the index table that provide offsets for the workpiece to be machined relative to the spatial coordinates of the index station. The offset can be one or more of the following: (a) translational offset from the indexing axis for a given fixture in the vertical plane; (b) translational offset from the indexing axis for a given fixture in the horizontal plane; and (c) rotational offset about the indexing axis for a given fixture. In this manner, at any given translational offset a further degree of freedom is available inasmuch as the face to be machined can be presented to a spindle at any desired rotational orientation in a machining plane available for the spindles(s) to be utilized and about an axis that coincides with or is parallel to the axis of the spindle(s). Additionally, a fixture can be mounted to the index table at any desired location along its corresponding indexing axis.

As used herein and in the appended claims, the term “offset” includes all orientations of a workpiece face to be machined while spaced from or rotated about the indexing axis of a given index station equipped with the fixture that carries that particular workpiece.

Referring to the drawings, FIG. 1 depicts an exemplary embodiment of a rotary transfer machine 10 according to the present invention. Rotary transfer machine 10 comprises an index table 12 having an axis of rotation and configured to include eight spaced Index Stations A through H. Index table 12 further includes workpieces 31-38 secured by fixtures 41-48 at the spaced indexing stations A through H. Preferably, the index table 12 has a substantially vertical axis of rotation. Mounted workpiece fixtures 41-48 are circumferentially spaced about the index table and positioned at a desired location along the radially outwardly extending corresponding indexing axes 61-68. Thus, mounted workpiece fixtures can be circumferentially spaced from one another about the index table while situated along the corresponding indexing axes at equal or unequal distances from the axis of rotation for the index table.

Index table 12 is configured to index each of Index Stations A through H with a machining cell or station 14. If desired, more than one machining cell or station can be provided about the index table 12. Each fixture 41-48 is also adapted to secure workpieces at a pre-determined offset from the respective indexing axes at Index Stations A through H. In this embodiment, each of the mounted workpiece fixtures 41-48 is adapted to present a different face of each workpiece 31-38 to be machined to a pre-determined spindle or group of spindles within multi-spindle machining cell 14 in a pre-determined orientation.

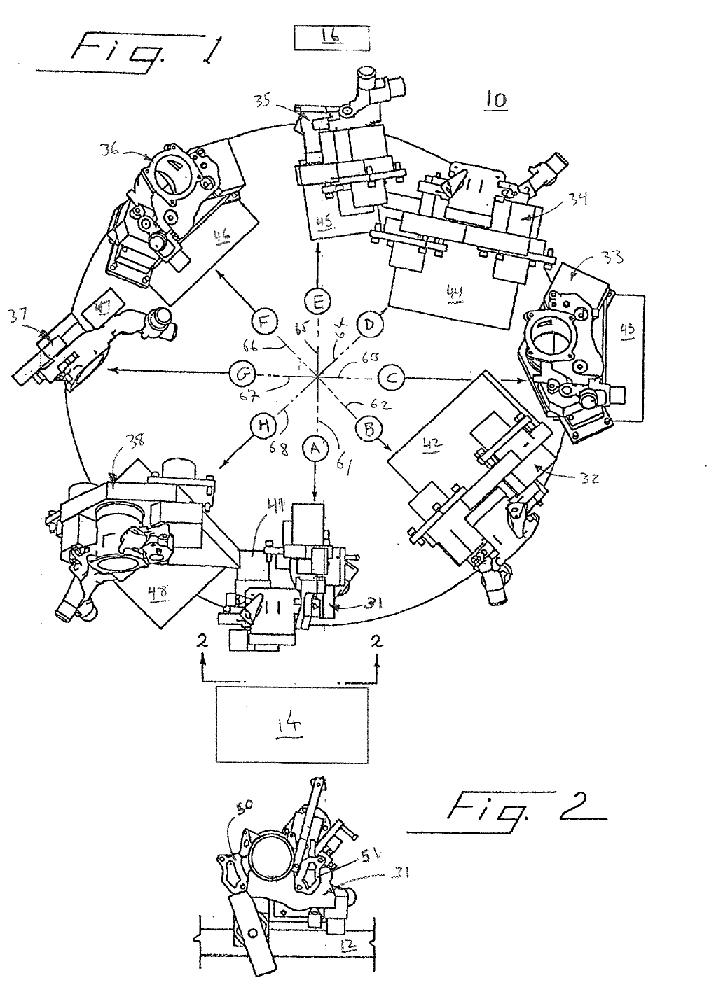

As shown in FIG. 2, the preselected workpiece face 50 for workpiece 31 is translationally offset relative to indexing axis 61 of Index Station A and workpiece face 51 is rotationally offset about indexing axis 61. Variable translational offsets for each of fixtures 41-48 are illustrated in FIG. 1 such that each of fixtures 41-48 presents a different workpiece face of the same part to the machining cell 14 when the respective Index Station is indexed to the machining cell 14. For example, when Index Station A is indexed to machining cell 14 as shown in FIG. 1, workpiece face 50 and workpiece face 51 are appropriately positioned relative to one or more spindles at the machining cell 14 so that those spindles have a maximum work volume available within the work envelope and all other spindles within machining cell 14 do not interfere (collide) with either workpiece 31 or fixture 41. While FIG. 1 is shown such that each fixture 41-48 presents a different face of its respective workpiece, a number of the fixtures can also include the same translational offsets or present the same face of the workpiece in a different orientation.

The translational offset can be horizontal or vertical, or both, relative to an indexing station of the index table 12. In this manner the available volume of the work envelope in a machining cell 14 is optimized because the desired workpiece face to be machined is pre-positioned relative to the intended spindle. For example, as shown in FIGS. 1 and 2, workpiece 31 is translationally offset horizontally as well as vertically by fixture 41 relative to Index Station A of index table 12. As such, workpiece faces 50 and 51 are positioned in their desired positions relative to the machining cell 14 such that face 50 and face 51 are properly aligned with the intended machining spindle (not shown) of the machining cell 14, but are presented offset and at a different rotational orientation relative to one another. Available work volume is optimized in this manner while potential collisions between the workpiece and spindles not in use are avoided.

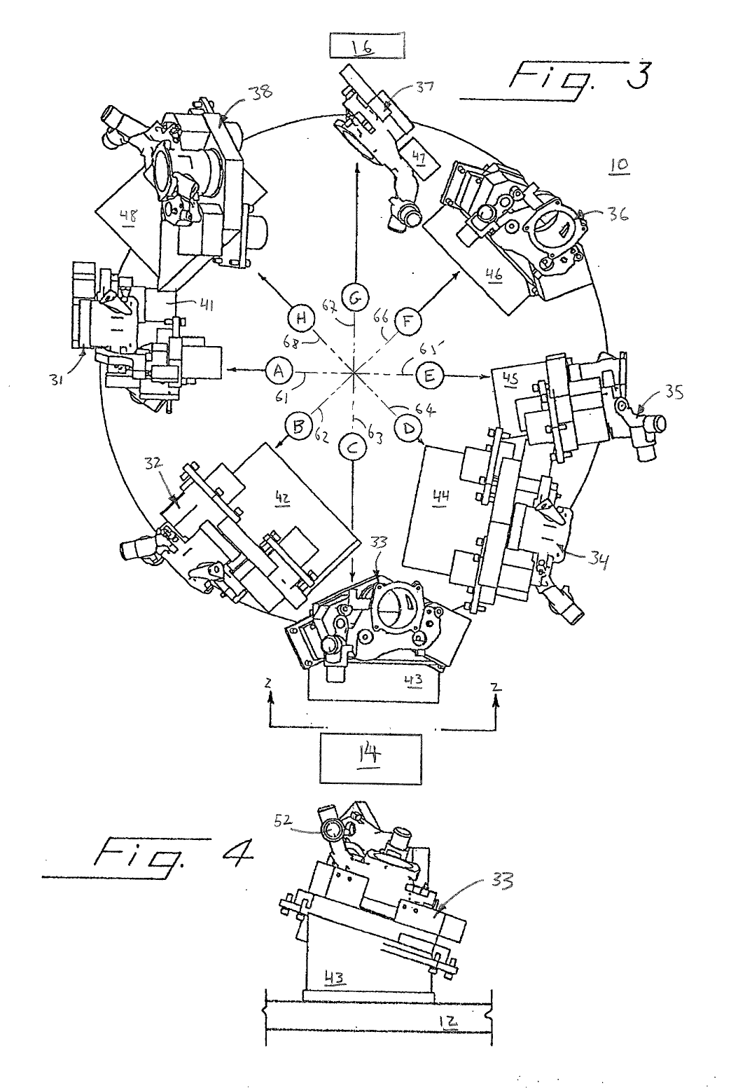

In FIG. 3, the index table 12 is shown indexed to a position where Index Station C is situated at the machining cell 14. As shown in FIG. 4, workpiece 33 is aligned with a different translational offset relative to its respective Index Station C than was workpiece 31 (FIG. 2). As such, workpiece 33, and in particular workpiece face 52, is presented to a different work envelope to be operated on by a different spindle at the machining cell 14 than that for workpiece 31. Thus, the available work envelopes for each spindle of the machining cell are utilized efficiently.

Fixtures can also be configured such that the mounting thereof to the index station is keyed. In this manner, a particular fixture can only be secured to a particular index station on index table 12. With such a configuration, the coordination between the machining cell 14 and the plurality of Index Stations A through H can be pre-determined and programmed into an appropriate control device such as a CNC control. Having keyed fixtures also eliminates, or at least greatly reduces, the possibility of an unintended portion of a workpiece being machined.

While FIGS. 1 and 3 depict an embodiment of the present invention with eight fixtures 41-48, each configured to hold a workpiece at a different orientation, it should be recognized that any number of fixtures may be used to provide the desired offset. It is also contemplated that not all fixtures need be mounted to the index table for some machining operations, such that in certain operations one or more index stations may not be occupied, and have no corresponding workpiece to be machined. Similarly, the rotary apparatus 10 of the present invention can include any plural number of index stations.

A method aspect of the present invention for machining a multi-face workpiece using a multi-spindle machining cell includes the step of mounting a multi-face workpiece to at least one fixture on a rotary index table having plural index stations and a workpiece fixture mounted to at least two of the index stations so that a pre-determined workpiece face of the multi-face workpiece to be machined is offset from the indexing axis of the corresponding index station when the so-produced fixture mounted workpiece is situated at its corresponding index station. Thereafter, the corresponding index station, bearing the fixture-mounted workpiece, is indexed to the machining cell for machining the pre-determined workpiece face.

In a typical example of use, a workpiece 31 having at least eight faces to be machined, e.g., an unmachined casting, is loaded into fixture 41 at operator station 16 and indexed to Index Station A to machining cell 14. After machining a pre-determined face or faces at Index Station A, this workpiece is unloaded at operator station 16 from fixture 41, or transferred to fixture 42 as workpiece 32, while a new workpiece 31 is mounted in fixture 41 for the next machining cycle when index station A is again positioned at machining cell 14. After workpiece 31 is indexed away from the machining cell 14, workpiece 32 at Index Station B is indexed one position to the machining station so as to present workpiece 32 at machining cell 14 for the machining of another face. The foregoing steps are then repeated, incrementing each consecutive workpiece bearing fixture to machining cell 14 until all pre-determined faces of each workpiece have been machined.

I claim:

1. A rotary apparatus for presenting workpieces to at least one multi-spindle machining cell at a machining station and comprising:
an index table rotatable about an axis of rotation and having plural index stations, each index station having a corresponding indexing axis;
a workpiece fixture mounted to at least two of the index stations at a pre-determined location along the corresponding indexing axis; and
at least one of the mounted workpiece fixtures adapted to present a workpiece face to be machined to at least one pre-determined spindle of said at least one multi-spindle machining cell so that the presented workpiece face is offset from the corresponding indexing axis of the corresponding index station.

2. The rotary apparatus in accordance with claim 1 wherein the presented workpiece face is translationally offset vertically.

3. The rotary apparatus in accordance with claim 1 wherein the presented workpiece face is translationally offset horizontally.

4. The rotary apparatus in accordance with claim 1 wherein the presented workpiece face is rotationally offset.

5. The rotary apparatus in accordance with claim 1 wherein the presented workpiece face is translationally offset vertically as well as horizontally.

6. The rotary apparatus in accordance with claim 1 wherein the presented workpiece face is offset rotationally as well as translationally.

7. The rotary apparatus in accordance with claim 1, wherein the index table has a substantially vertical axis of rotation.

8. The rotary apparatus in accordance with claim 1, wherein the mounted workpiece fixtures are circumferentially spaced about the index table from one another.

9. The rotary apparatus in accordance with claim 1, wherein each of the fixtures present the same workpiece to the machining cell in a orientation different from one another.

10. The rotary apparatus in accordance with claim 1 wherein said mounted workpiece fixture at the same index station presents plural workpiece faces for machining that are offset from the indexing axis of the index station.

11. The rotary apparatus in accordance with claim 1 wherein the mounted workpiece fixtures are circumferentially spaced from one another about the index table and are situated along the corresponding indexing axes at unequal distances from said axis of rotation.

12. A method for machining a multi-face workpiece using a multi-spindle machining cell which comprises the steps of:
mounting the multi-face workpiece to at least one fixture on a rotary index table having plural index stations along radially extending corresponding indexing axes and a workpiece fixture mounted to at least two of the index stations so that a pre-determined workpiece face to be machined at one of the index stations is offset from the corresponding indexing axis of said one index station when the fixture-mounted workpiece is at said one index station; and
indexing said one index station bearing the fixture-mounted workpiece to the machining cell for machining the pre-determined workpiece face.

13. The method in accordance with claim 12 wherein the pre-determined workpiece face is translationally offset vertically.

14. The method in accordance with claim 12 wherein the pre-determined workpiece face is translationally offset horizontally.

15. The method in accordance with claim 12 wherein the pre-determined workpiece face is translationally offset horizontally as well as vertically.

16. The method in accordance with claim 12 wherein the predetermined workpiece face is offset rotationally.

17. The method in accordance with claim 12 wherein the predetermined workpiece face is offset translationally as well as rotationally.
